(19) United States
(12) Patent Application Publication
(10) Pub. No.: US 2009/0272066 A1
(43) Pub. Date: Nov. 5, 2009

(54) Fastening assembly

(75) Inventors: Falk Rosenkranz, Wildhaus (CH); Holger Basche, Meiningen (AT); Bernhard Sander, Munich (DE); Marc Schaeffer, Feldkirch-Nofels (AT)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/387,211

(22) Filed: Apr. 28, 2009

(30) Foreign Application Priority Data
May 5, 2008 (DE) 10 2008 001 552.0

(51) Int. Cl. E04B 1/38; F16B 35/00

(52) U.S. Cl. 52/700; 411/425

(57) ABSTRACT

A fastening assembly (11) for fastening a mounting part (6) to a constructional component (7) and including a fastening element (12) having a shaft (14) extending along a longitudinal axis (13), a holding portion (15) projecting radially at a first end of the shaft, and an anchoring portion (16) provided at the opposite, second, free end of the shaft for anchoring in the constructional component (7), and a shear force transmission element (21) provided on the fastening element (12) between the holding portion (15) and the anchoring portion (16) in the set state of the fastening assembly in the through-opening (8) of the mounting part (6), with the shear force transmission element (21) having, in a mounted state thereof, an axial length (L) that is smaller than its initial axial length and that is reduced from its initial axial length (H) by the holding portion (15) of the fastening element (12).

### BACKGROUND OF THE INVENTION

1. Field of the Invention

The present invention relates to a fastening assembly for fastening a mounting part to a constructional component, e.g., to a ceiling or a wall of a mineral material such as, e.g., concrete or masonry, with a fastening element such as, e.g., an expansion dowel or a concrete screw, and with a shear force transmission element, with the mounting part having a through-opening for the fastening element, with the fastening element having a shaft extending along a longitudinal axis with a holding portion projecting radially from a first end of the shaft and an anchoring portion extending from the opposite, second, free end of the shaft for being anchored in the constructional component, and with the shear force transmission element being supported on the fastening element and located between the holding portion and the anchoring portion in the through-opening of the mounting part.

2. Description of the Prior Art

Mounting parts are usually fastened to the constructional components by more than one fastening element, for which reason this type of fastening is known as a group fastening. In a first step, boreholes are produced in the constructional component corresponding to the quantity and shape of fastening elements. Then, the mounting part is positioned on the constructional component in such a way that its through-openings are substantially aligned with the boreholes, and the fastening elements are then inserted into the boreholes by through-mounting, i.e., through the through-openings, and anchored therein.

When a self-tapping screw, for example, is used as a fastening element, e.g., a concrete screw, which itself forms a complementary thread in the wall of the borehole when set, the minimum inner dimensions of the through-openings must correspond at least to the outer diameter of the screw thread in order for it to be guided through the through-openings in the mounting part which are advantageously round. Since the thread of a screw of this kind usually does not extend up to the first end of the shaft with the holding portion, there is a relatively large gap between the inner wall of the through-opening in the mounting part and the outer shaft side of the screw when the fastening element has been set. Further, the boreholes are usually drilled with a large tolerance so that the through-openings are also formed, e.g., drilled, so that their inner dimensions are somewhat larger than required for the passage of the anchoring portion of the fastening element. For the above reasons, a fastening assembly of this kind for group fastenings is not suitable for transmitting shear loads or transverse loads.

U.S. Pat. No. 3,418,013 discloses a fastening element in form of a screw which has, in some areas at the first end of the shaft at its outer side, a trapezoidal thread adjoining the screw head serving as a holding portion. The trapezoidal thread contacts the inner wall of the through-opening when the fastening element has been set and, accordingly, makes it possible to transmit shear or transverse loads.

It is disadvantageous in the known solution that the surface for transmitting the occurring transverse forces or shear forces is limited. Further, with this form of the fastening element, the shear forces are not transmitted from the mounting part to the fastening element in a uniform manner, which leads to damage in some areas of the mounting part and/or fastening element in the event of higher shear forces.

U.S. Patent Publication 2004/0071524 A1 discloses a screw with a screw head with a stepped outer diameter or with a thickening of the shaft which is arranged under the screw head and has a stepped outer diameter and which penetrates into the through-opening in the mounting part at least in some areas in the clamped state of the fastening element.

This solution is disadvantageous in that a separate screw is required for every thickness of the mounting part so that the largest possible surface is available for transmission of shear forces. When this screw is used with a mounting part which has a greater thickness than the axial extension of the corresponding shaft thickening, the shear forces are introduced into the screw at a distance from the constructional component resulting in unwanted bending moments in the screw serving as a fastening element. When such a screw is used with a mounting part having a thickness which is less than the axial extension of the corresponding shaft thickening, the screw head is not able to contact the mounting part so that the latter is not firmly fastened to the constructional component.

European Patent EP 774 587 B1 discloses a fastening assembly with a fastening element and with a shear force transmission element produced in situ. The gap between the fastening element and the through-opening in the mounting part is filled with a hardenable compound after setting the fastening element. After the compound hardens, the shear forces can be transmitted from the mounting part to the fastening element.

The solution proposed in EP 774 587 B1 is disadvantageous in that it is complicated to mount a fastening assembly of this kind. Aside from the elements of the fastening assembly, additional elements are needed such as vessels for the hardenable compound and a delivery device such as, e.g., a dispenser, for dispensing the hardenable compound which usually comprises multiple components. Further, a shear force cannot be transmitted by the shear force transmission element produced in situ until after the compound hardens.

### SUMMARY OF THE INVENTION

It is the object of the present invention to provide a fastening assembly for fastening a mounting part to a constructional component which is usable in an all-purpose manner for mounting parts of different thickness.

This and other objects of the present invention, which will become apparent hereinafter, are achieved by providing a fastening assembly in which the shear force transmission element has, in the mounted condition of the fastening assembly, an axial length which is smaller than its initial axial length and which is reduced by the holding portion of the fastening element.

When the fastening element is set or tightened, the radially projecting holding portion of the fastening element is displaced in direction of the mounting part, and the length of the shear force transmission element is reduced or compressed from its initial axial length to an axial length in the mounted state which substantially corresponds to the thickness of the mounting part when the holding portion of the fastening element contacts the mounting part. The holding portion can be brought into contact with the mounting part regardless of the thickness of the mounting part, without the need to provide a correspondingly formed fastening element for every mounting part thickness.

When the shear force transmission element is reduced in its axial length from its initial axial length by the holding portion of the fastening element, the shear force transmission element expands radially outwardly and/or radially inwardly depending on the characteristics of the material used to produce it, so that any gaps between the shear force transmission element and the inner wall of the through-opening in the mounting part and the shaft of the fastening element are closed. This advantageously ensures a backlash-free transmission of the shear forces from the mounting part to the fastening element or fastening elements.

Accordingly, transmission of shear forces into the fastening element is ensured over the entire surface of the inner wall of the through-opening available for this purpose. The fastening assembly according to the invention not only ensures a simple mounting, but also in case of a group fastening, ensures a uniform introduction of shear forces into the fastening element in every fastening element.

The shear force transmission element advantageously has a sleeve-shaped or prismatic shape, or a shape which at least approximates this shape, with an opening for receiving at least a portion of the shaft of the fastening element. The inner dimensions of the shear force transmission element, e.g., the inner diameter when a shaft of the fastening element has a circular cross section, substantially correspond to the corresponding outer dimensions of the shaft, e.g., the outer diameter in the shaft of the fastening element with a circular cross-section. The outer dimensions of the shear force transmission element, e.g., the outer diameter in case of a through-opening with a circular cross-section in the mounting part, substantially correspond to the corresponding inner dimensions of the through-opening, e.g., the inner diameter of a through-opening with a circular cross-section.

The user is advantageously offered a fastening element with a shear force transmission element arranged directly at the shaft. Alternatively, the shear force transmission element is being arranged on the shaft of the fastening element when the fastening assembly is mounted, for which purpose the sleeve-shaped shear force transmission element is provided, for example, with a longitudinal slot or is pushed onto or screwed onto the fastening element.

In a particularly advantageous manner, the fastening element is a concrete screw which has, as a holding portion, a screw head with torque application means, e.g., a hexagon head or recessed polygon head, for rotary driving means of a setting device and has a self-tapping thread as an anchoring portion.

Instead of a self-tapping thread, a screw serving as a fastening element can also have, as an anchoring portion, a threaded portion proceeding from the second end of the shaft on which, e.g., a nut can be screwed as locking means. This type of fastening element is used, for example, in fastening assemblies which are accessible from two opposite sides.

Alternatively, the fastening element can be formed as an expansion dowel which has, as holding portion, a screw head with torque application means and, as an anchoring portion, an expansion element. The expansion element can have, e.g., an expansion body and an expansion sleeve which can be expanded by the expansion body. Further, the fastening element can also have an anchoring portion which is provided, for example, with a shaped profile and which is set in a hardenable compound introduced into the borehole for anchoring.

Instead of a screw head as a holding portion, each of these fastening elements can also have a threaded portion proceeding from the first end of the shaft, on which a nut can be screwed, optionally, with a washer. When screwing on, the nut and, as the case may be, the washer are displaced in direction of the mounting part, the axial length of the shear force transmission element being reduced by the latter in an axial direction.

The shear force transmission element is preferably a spring element whose initial axial length can easily be adapted to the respective thickness of the mounting part. The outer dimensions, e.g., the outer diameter, of the spring element substantially correspond to the corresponding inner dimensions of the through-opening in the mounting part. The inner dimensions of the spring element substantially correspond to the corresponding outer dimensions of the shaft of the fastening element. For this application, series-produced spring elements can be resorted to so that a shear force transmission element of this kind and, therefore, the fastening assembly as a whole is particularly economical. In a particularly advantageous manner, the spring element is a helical spring which is advantageously made of metal, e.g., a wire of appropriate thickness.

In another advantageous embodiment, the shear force transmission element has a first axial portion and at least one second axial portion which overlaps at least in some areas with the first axial portion. The axial portions can be displaced relative to one another at least in the axial direction. When the axial length is reduced from the initial axial length of the shear force transmission element, the portions, which already overlap in some areas, overlap to a greater extent so that a sufficiently large surface is available for transmitting shear forces from the mounting part to the fastening element. In the mounted state, the axial extension of the overlap of the shear force transmission element is preferably greater than half of the thickness of the mounting part. The shear force transmission element can be formed, for example, as a cup spring whose turns advantageously overlaps in some areas already in the unclamped state of the fastening element and, accordingly, form at least two axial portions.

In another advantageous embodiment, compressible apertures are provided in the wall of the shear force transmission element which makes it possible to reduce the axial length of the shear force transmission element with only a slight pressure on the shear force transmission element in the axial direction even when the shear force transmission element is made of a stiff material. A plurality of compressible apertures are advantageously provided along the circumference of the shear force transmission element, optionally, at a distance from one another axially, and also advantageously overlap each other at least in some areas, so that the shear force transmission element is easily compressible and accordingly can be reduced in axial length in a simple manner.

The shear force transmission element is preferably formed as one piece, which ensures a simple assembly of the fastening assembly and an economical manufacture, particularly of the shear force transmission element.

An indicator portion which radially overlaps the holding portion of the fastening element is preferably provided at one end of the shear force transmission element facing the holding portion of the fastening element. When the fastening element is set, the indicator portion allows the user or an inspector to visually inspect from the outside to ascertain whether or not a shear force transmission element was provided in the set fastening assembly. The indicator portion is advantageously an annular element, an inner opening being provided which further ensures that the fastening element is guided through into the constructional component. Alternatively, the indicator portion is a material portion which projects radially over some areas of the holding portion of the fastening element in the mounted state. The indicator portion is formed, for example, in one piece, e.g., is cast along with the shear force transmission element. Alternatively, the indicator portion is a separate part which is arranged at the shear force transmission element or is provided at the fastening assembly when mounting the latter.

Spring elements projecting in axial direction are preferably provided at least at one of the free edges of the shear force transmission element and can be deflected or deformed by the holding portion of the fastening element. The reduction of the axial length from the initial axial length can be ensured essentially solely by these spring elements so that the rest of the shear force transmission element need not be adapted to the requirements for deformability but to the requirements for the transmission of force with respect to selection of material. In the mounted state of the shear force transmission element, the projecting spring elements advantageously face the holding portion of the fastening element so that the spring elements are deflected or deformed directly by the holding portion when the holding portion is displaced in direction of the mounting part. In an alternative arrangement, the projecting spring elements face the constructional component in the mounted state of the shear force transmission element and are deflected or deformed when contacting the constructional component when the holding portion is displaced in the direction of the mounting part. To ensure an advantageous reduction of the axial length, particularly when the remaining, advantageously sleeve-shaped portion of the shear force transmission element is made of a very stiff, hard-to-deform material, spring elements projecting in axial direction are provided at both axial, free edges. The spring elements are advantageously formed integral with the remaining portion of the shear force transmission element and, in a particularly advantageous manner, are formed at the same time during the production of the latter.

The shear force transmission element is advantageously made of an elastic material which ensures easy deformation of the shear force transmission element when the fastening assembly is clamped. Alternatively, the shear force transmission element is made of a non-elastic material which can nevertheless be compressed at least in some areas.

The shear force transmission element is preferably made of a plastic material, advantageously by injection molding, which makes it possible to manufacture the shear force transmission element simply and economically. Any plastic material having a sufficient strength and modulus of elasticity to ensure a proportionate transmission of force in the direction of the acting shear forces is essentially suitable. Alternatively, the shear force transmission element can be made of a metal, for example, which is suitable for the intended use.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional view of a first embodiment of a fastening assembly according to the present invention;

FIG. 2 a cross-sectional view of a second embodiment of a fastening assembly according to the present invention;

FIG. 3 a side view of a third embodiment of a shear force transmission element;

FIG. 4 a side view of a fourth embodiment of a shear force transmission element; and

FIG. 5 a side view of a modification of the shear force transmission element shown in FIG. 4.

### DETAILED DESCRIPTION OF THE PREFERRED EMBODIMENTS

A fastening assembly 11 according to the present invention, which is shown in FIG. 1 is designed for fastening a mounting part 6 to a constructional component 7 and includes a concrete screw as fastening element 12 and a shear force transmission element 21. The mounting part 6 has a through-opening 8 for the fastening element 12 and a thickness D. The through-opening 8 is round in this embodiment. The fastening element 12 has a shaft 14 extending along a longitudinal axis 13 with a holding portion 15 in the form of a screw head projecting radially from a first end, and an anchoring portion 16 extending from the opposite, second, free end and having a self-tapping thread 17 for anchoring in the constructional component 7.

The sleeve-shaped shear force transmission element 21 is a spring element in the form of a helical spring made of metal and is provided at the fastening element 12 in such a way that it extends in the through-opening 8 of the mounting part 6 when the fastening element 12 is set. The inner diameter I of the shear force transmission element 21 substantially corresponds to the outer diameter A of the shaft 14, and the outer diameter K of the shear force transmission element 21 substantially corresponds to the inner diameter N of the through-opening 8. The shear force transmission element 21 has an initial axial length H which is greater than the thickness D of the mounting part. In the set state, the shear force transmission element 21 has an axial length L that is smaller than its initial axial length H, the shear force transmission element 21 being reduced to its axial length L by the holding portion 15 of the fastening element 12.

In order to mount the fastening assembly 11, a borehole 9 is first produced at the respective location in the constructional component 7 and has a diameter P which is smaller than the outer thread diameter Q of the fastening element 12 in the form of a concrete screw. The mounting part 6 is then positioned at the constructional component 6 in such a way with respect to the prepared borehole 9 that the fastening element 12 can be inserted into the borehole. For insertion mounting of the fastening element 12, the inner diameter N of the through-opening 8 is somewhat larger than the outer thread diameter Q of the fastening element 12.

The shear force transmission element 21 has already been arranged at the fastening element 12 on the work side. The user guides the fastening element 12 through the through-opening 8 into the borehole 9 by the free end of the shaft 14 and screws the fastening element 12 into the borehole 9 until the holding portion 5 of the fastening element 12 comes into contact with the mounting part 6. In doing so, the shear force transmission element 21 is reduced from its initial axial length H to axial length L by the holding portion 15, which axial length L substantially corresponds to the thickness D of the mounting part. An advantageous transmission of shear forces from the mounting part 6 to the fastening element 12 is ensured by the contact surfaces between the mounting part 6 and the shear force transmission element 21 and by the contact surfaces between the shear force transmission element 21 and the fastening element 12.

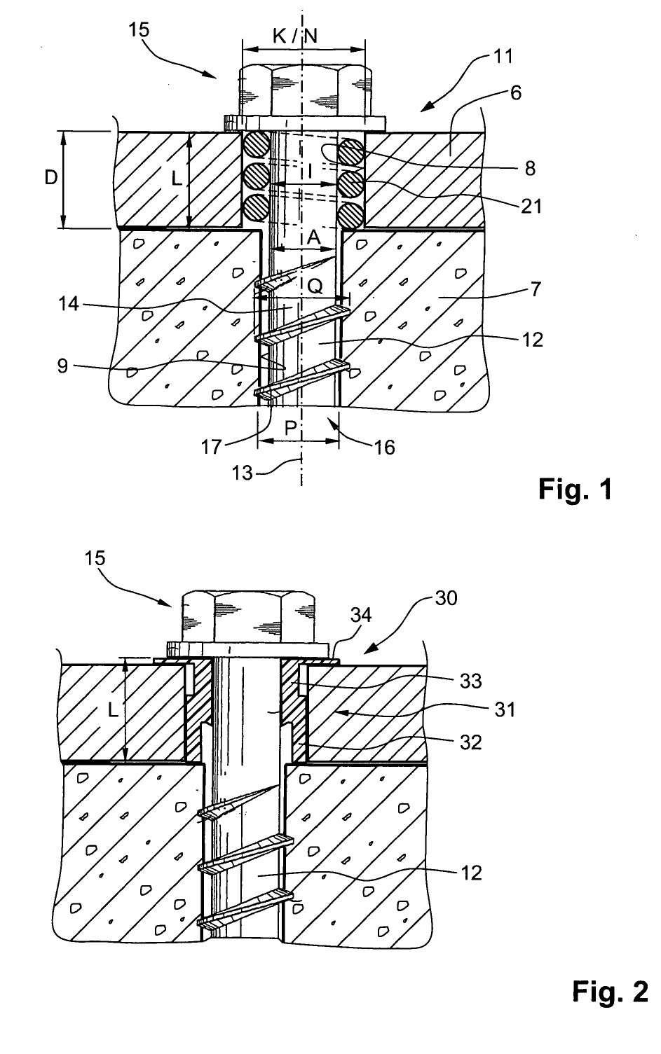

In the embodiment of the invention according to FIG. 2, the shear force transmission element 31 of the fastening assembly 30 is formed in one piece and has a first axial portion 32 and a second axial portion 33 which overlaps in some areas with the first axial portion 32. The axial portions 32 and 33 can be displaced relative to one another in axial direction by the holding portion 15 of the fastening element 12. The shear force transmission element 31 is made of a plastic material. During the reduction of the initial axial length H of the shear force transmission element 31 to axial length L, the shear force transmission element 31 advantageously expands radially outward so that any gap between the shear force transmission element 31 and the fastening element 12 or between the shear force transmission element 31 and the mounting part 6 is closed. A radially projecting indicator portion 34 which is advantageously ring-shaped is provided at the end of the shear force transmission element 31 facing the holding portion 15 of the fastening element 12. Based on the indicator portion 34 which projects radially in the set state of the fastening assembly 30, the user or an inspector can determine at a glance that a shear force transmission element 31 has been provided in this fastening assembly 30.

In this embodiment, the indicator portion 34 is formed integral with the shear force transmission element 31. However, an indicator portion can, of course, also be provided as a separate part, a loose part or a part which is fixed to the shear force transmission element 21, e.g., in a shear force transmission element 21 such as that shown in FIG. 1.

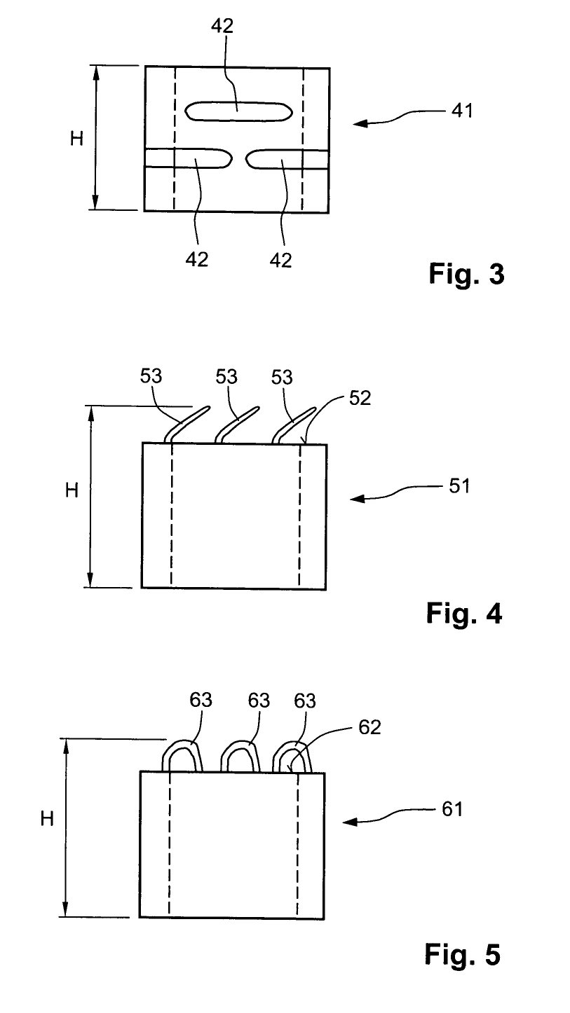

The sleeve-shaped shear force transmission element 41 according to FIG. 3, has a plurality of compressible apertures 42 which are provided in the wall of the shear force transmission element 41 in two rows at a distance from one another axially so as to overlap each other in some areas circumferentially.

In FIG. 4, the sleeve-shaped shear force transmission element 51 has spring elements 53 at the free edge 52 of the shear force transmission element 51 which project in axial direction and are formed as lugs which project at one side.

In FIG. 5, the sleeve-shaped shear force transmission element 61 has spring elements 63 in the form of arc portions at the free edge 62 of the shear force transmission element 61 which project in axial direction.

The shear force transmission element 51 and the shear force transmission element 61 are advantageously formed in one piece from a plastic material. The spring elements 53 and 63 projecting in axial direction are advantageously formed at the same time as the shear force transmission element 51 and 61, respectively.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A fastening assembly for fastening a mounting part (6) to a constructional component (7), comprising a fastening element (12) having a shaft (14) extending along a longitudinal axis (13) and extendable through a through-opening (8) formed in the mounting part (6), a holding portion (15) provided at a first end of the shaft (14) and projecting radially thereat, and an anchoring portion (16) provided at a second, free end of the shaft (14) for being anchored in the constructional component (7); and a shear force transmission element (21; 31; 41; 51; 61) mounted on the fastening element (12) between the holding portion (15) and the anchoring portion (16) in a set state of the fastening element (12) when the fastening element (12) extends through the through-opening (8) of the mounting part (6), the shear force transmission element (21; 31; 41; 51; 61) having, in a mounted state thereof, an axial length (L) which is smaller than an initial axial length (H) thereof and which is reduced from the initial length (H) thereof by the holding portion (15) upon setting of the fastening assembly.

2. A fastening assembly according to claim 1, wherein the shear force transmission element (21) is a spring element.

3. A fastening assembly according to claim 2, wherein the spring element is a helical screw.

4. A fastening assembly according to claim 1, wherein the shear force transmission element (31) has a first axial portion (32) and at least one second axial portion (33) which overlaps at least in some areas the first axial portion (32), and wherein the axial portions (32, 33) can be displaced relative to each other at least in an axial direction.

5. A fastening assembly according to claim 1, wherein compressible openings (42) are provided in a wall of the shear force transmission element (41).

6. A fastening assembly according to claim 1, wherein the shear force transmission element (21; 31; 41; 51; 61) is formed as a one-piece part.

7. A fastening assembly according to claim 1, wherein the shear force transmission element (31) has, at an end thereof adjacent to the holding portion (15) of the fastening element (12), an indicator portion (34) projecting radially beyond the holding portion (15).

8. A fastening assembly according to claim 1, wherein the shear force transmission element (51; 61) has, at least at one of free ends thereof (52; 62) axially projecting spring elements (53; 63).

9. A fastening assembly according to claim 1, wherein the shear force transmission element 931; 41; 51; 61) is formed of a plastic material.

10. A fastening assembly according to claim 1, wherein the fastening element (12) is formed as a concrete screw.
